(19) United States
(12) Patent Application Publication
(10) Pub. No.: US 2026/0174625 A1
(43) Pub. Date: Jun. 25, 2026

(54) INTRAORAL VIBRATION DEVICES AND METHODS FOR AMELIORATING MIDDLE EAR DISORDERS

(71) Applicant: PerioTech, LLC, Palm Beach Gardens, FL (US)

(72) Inventor: Richard JOHNSON, Palm Beach Gardens, FL (US)

(21) Appl. No.: 18/990,460

(22) Filed: Dec. 20, 2024

(51) Int. Cl. A61H 21/00; A61H 23/02

(52) U.S. Cl. CPC A61H 21/00; A61H 23/0245; A61H 23/0254; A61H 2201/1604; A61H 2201/165; A61H 2201/5005; A61H 2201/5076; A61H 2205/027

(57) ABSTRACT

A device and method for treating a middle ear disorder in a patient includes providing to the patient an intraoral vibration device having a mouthpiece for contacting an oral cavity of the patient, wherein the intraoral vibration device has a frequency tuned to treat the middle ear disorder, and providing instructions for using the intraoral vibration device. The instructions provided for using the intraoral vibration device include placing the mouthpiece over at least one portion of the oral cavity, and applying a vibratory force at the frequency to treat the middle ear disorder.

### TECHNICAL FIELDS

This disclosure concerns intraoral vibration devices and methods for ameliorating middle ear disorders and, more specifically, a method to improve treatment of middle ear disorders and facilitate general health using mechanical vibration.

### BACKGROUND

Middle ear disorders affect children and adult patients of all ages. Their causes may vary, and include infection, trauma, injuries, structural abnormalities, and/or tumors. These disorders may be managed through a combination of medical and surgical treatments.

One example of a middle ear disorder may include Tensor Tympani Syndrome (TTS) (also referred to as Tonic Tensor Tympani Syndrome (TTTS)). See, e.g., Collins L, May S, A Beginner's Guide to Tensor Tympani Syndrome, TrebleHealth, which is incorporated by reference in its entirety. TTS may cause the tensor tympani muscle (TTM) to become spastic or contracted, which may cause several problems. The TTM is located in the middle ear (also referred to as the middle ear cavity). The TTM is one of two middle ear muscles that support the three middle ear bones, called the ossicles.

Sometimes, the TTM can experience a spasm and contract even without loud sounds provoking a reflex. This is known as an Acoustic Reflex and may be present in a healthy auditory system. However, this hyper-reaction may also be caused by anxiety resulting from tinnitus or hyperacusis. This is because people who suffer from either condition are more likely to be in a persistent, low-level state of anxiety, fearing the sudden onset of noises or ear pain. The TTM contraction can also be caused by general anxiety. Sometimes, tinnitus is a frequent comorbidity with TTS.

Studies suggest that the TTM may be involved in otitis media (OM). See, e.g., Abdelhamid M M, Paparella M M, Schachern P A, Yoon T H, Histopathology of the tensor tympani muscle in otitis media, Eur Arch Otorhinolaryngol, 1990; 248(2):71-8, which is incorporated by reference in its entirety. The study evaluated human temporal bones with and without otitis media using light microscopy to determine the pathological changes of the TTM and tendon. Fatty cell infiltration and degenerative changes of the muscle fibers were observed in non-otitis and otitis media groups, but were greater in those cases with otitis media. Inflammatory cell infiltration and fibroblastic reactions occurred more often in chronic and purulent OM, and hypercontracted fibers were more frequent in serous and chronic OM. The study indicated that the human TTM and tendon are pathologically involved in the inflammatory process of OM.

### SUMMARY

According to an exemplary embodiment of the present disclosure, a method for treating a middle ear disorder in a patient is described. The method includes providing to the patient an intraoral vibration device having a mouthpiece for contacting an oral cavity of the patient, wherein the intraoral vibration device has a frequency tuned to treat the middle ear disorder, and providing instructions for using the intraoral vibration device. The instruction includes placing the mouthpiece over at least one portion of the oral cavity and applying a vibratory force at the frequency to treat the middle ear disorder.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

### BRIEF DESCRIPTION OF THE DRAWINGS

The accompanying drawings constitute a part of this specification. The drawings illustrate several embodiments of the present disclosure and, together with the description, serve to explain the principles of the disclosed embodiments as set forth in the accompanying claims. The patent or application file contains at least one drawing executed in color. Copies of this patent or patent application publication with color drawing(s) will be provided by the Office upon request and payment of the necessary fee.

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. In the drawings:

FIG. 1A depicts an illustrative vibrational dental device according to one aspect of the disclosure;

FIG. 1B depicts an illustrative vibrational dental device, such as that depicted in FIG. 1A placed in the mouth of a user, according to one aspect of the disclosure;

Reference will now be made in detail to exemplary embodiments. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

### DETAILED DESCRIPTION

It is to be understood that both the foregoing general description and the following detailed description are exemplary and explanatory only and are not restrictive of the claims.

The disclosed embodiments relate to intraoral vibration devices and methods for ameliorating middle ear disorders. Advantageously, embodiments of the present disclosure can be implemented to provide improvements to the treatment of middle ear disorders.

Described herein are intraoral vibration devices and methods for ameliorating middle ear disorders. In certain embodiments, intraoral vibration devices may include a mouthpiece configured to transmit vibration to all or a portion of the patient's teeth, gums, mouth, or oral cavity to treat middle ear disorders.

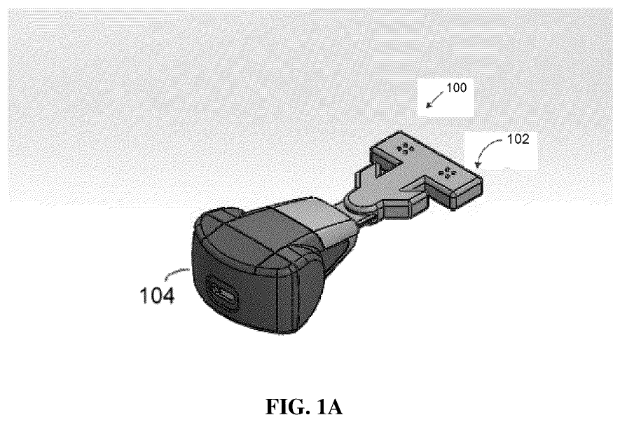

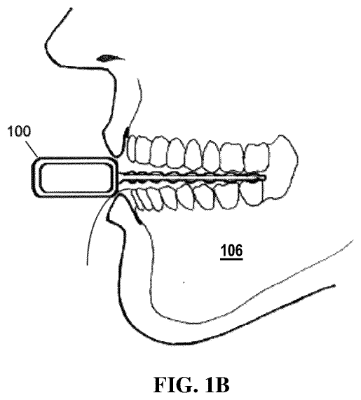

Referring to FIGS. 1A-1B, an exemplary vibration device 100 includes a mouthpiece 102 operatively connected to a housing 104. The mouthpiece 102 can be separable from the housing 104 for interchangeability between users or for ease of cleaning. The mouthpiece 102 can include one or more oral tissue-contacting portion, such as a biteplate or probe for contacting teeth, gums or other oral tissues. As shown, in FIG. 1A, the mouthpiece can include a biteplate which can be appropriately shaped to cover occlusal surfaces of some or all of a patient's dentition. Other shapes for the mouthpiece are possible. For example, the mouthpiece can be configured to abut the lingual and buccal lateral sides of the alveolar ridge either with or without occlusal contact or, when no teeth are present, contact with gums overlying the alveolar ridge. A vibration generator can be located in the mouthpiece 102 or the housing 104 to vibrate the mouthpiece 102. The housing 104 can also include the electronics to run the motor the vibrator, collect usage and device operation data, collect data from sensors in the mouthpiece or base, and store data in memory. The housing 104 can include a data interface which can be wired or wireless to allow a data connection to other devices. The housing 104 can also include a power interface to allow charging of any onboard power sources, such as batteries or capacitor banks. The mouthpiece 102 can be electrically interconnected to the housing 104. FIG. 1B depicts an illustrative dental device 100, such as that described above with reference to FIG. 1A, inserted in the mouth of a human user 106 and engaging the occlusal surfaces of the molars. The mouthpiece of the dental device 100 can, as described above, be sized and shaped to contact any dental tissue, including some or all of the teeth, specific regions of the gums, or both.

As is known in the art, the vibration generator can include an electric motor connected to an eccentric weight, or can be a piezo generator, as well as other known expedients. Accordingly, when the mouthpiece 102 is placed in a patient's mouth and the dental device is 100 turned on, the vibration of the mouthpiece 102 will place vibratory force repetitively on the teeth and/or other oral tissues.

In some embodiments, intraoral vibration may be administered using illustrative device 100 to treat middle ear disorders. In some embodiments, intraoral vibration may be administered to treat a particular type of middle ear disorder. In some embodiments, intraoral vibration may be administered at a frequency that may treat a particular type of middle ear disorder.

In some embodiments, the patient can be instructed to use the appliance for a prescribed time and duration to treat middle ear disorders. In an example, the patient can be instructed to use the appliance for one or more treatment sessions daily, where a treatment session is five minutes, over a treatment period of one or more days, weeks or months. The treatment period may be indefinite as a general adjunct to improved health and resistance to and/or recovery from middle ear disorders.

In some embodiments, intraoral vibration may be administered using illustrative device 100 to treat middle ear disorders. In some embodiments, intraoral vibration may be administered to treat a particular type of middle ear disorder. In some embodiments, intraoral vibration may be administered at a frequency that may treat a particular type of middle ear disorder.

In some embodiments, a type of middle ear disorder may include tinnitus. In some embodiments, a type of middle ear disorder may include otitis media (OM). In some embodiments, a type of middle ear disorder may include tensor tympani syndrome (TTS).

In some embodiments, intraoral vibration may be administered to a mouth, tooth, gum, implant, or oral cavity of a patient to treat a middle ear disorder. In some embodiments, intraoral vibration may be administered to a particular anatomical structure of a patient. In some embodiments, intraoral vibration may be directed to or aimed at a particular anatomical structure of a patient. In some embodiments, intraoral vibration may be directed to or aimed at any bone, muscle, bony canal, or other anatomical structure of the patient.

In some embodiments, intraoral vibration may be administered to a patient and may cause the vibration of a tensor tympani muscle of a patient. In some embodiments, intraoral vibration may be administered to a patient and may cause the vibration of the stapedius. In some embodiments, intraoral vibration may be administered to a patient and may massage and/or relax a muscle of the patient.

In some embodiments, the vibration can be applied along multiple axes or selected to be primarily on a single axis. The primary anatomic reference directions with reference to a standing human are superior-inferior (up and down), anterior-posterior (front to back), medial-lateral (side to side). Because mastication places loading on oral structures primarily in the superior-inferior direction through mandibular action, it may be advantageous to choose vibrational loading along other axes either separately or in combination.

### Intraoral Vibration Devices

According to an aspect of the present disclosure, an intraoral vibration device that vibrates at one or more predetermined frequencies is provided. In some embodiments the vibrational frequency is fixed within a lower bound and an upper bound. The lower bound can be greater than about 110 Hz, 105 Hz, 100 Hz, 95 Hz, 90 Hz, 85 Hz, 80 Hz, 75 Hz, 70 Hz, 65 Hz, 60 Hz, 55 Hz, 50 Hz, 45 Hz, or less. The upper bound can be greater than about 115 Hz, 120 Hz, 125 Hz, 130 Hz, 135 Hz, 140 Hz, 145 Hz, 150 Hz, or more. In some embodiments, the frequency varies within a lower and an upper bound. In some embodiments two or more frequencies, fixed or varying, are employed. In some embodiments, the frequency may be fixed at an upper bound, a lower bound, or a frequency within a lower and an upper bound. In some embodiments, the frequency may be tuned based on a frequency associated with treating one or more middle ear disorders.

In some embodiments the duration of a treatment session can be specified to be greater than about 30 seconds, 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, or more; or specified to be less than about 20 min, 19 min, 18 min, 17 min, 16 min, 15 min, 14 min, 13 min, 12 min, 10 min, 9 min, 8 min, 7 min, 6 min, 5 min, 4 min, 3 min, 2 min, 1 min, 30 seconds, or less.

FIG. 1 depicts an intraoral vibration device according to an example. The intraoral vibration device can include a mouthpiece and a vibrational source connected to each other. The mouthpiece is configured to be provided between the occlusal surfaces of a user's teeth, and to be bite down by the user to contact the user's dentition during the treatment. The mouthpiece can cover at least the teeth, gums, mouth, or implant of the user. The vibrational source is configured to provide vibration to the mouthpiece at a preset frequency and acceleration. The vibrational source may be configured to provide vibration to the mouthpiece at a dynamic frequency and a dynamic acceleration.

To achieve the maximum desired results of middle ear disorder treatment, further studies are still needed to optimize the parameters of intraoral vibration. Such parameters may include frequency, acceleration, and dosage. Dosage may include duration per use, number of uses per day, or number of days of use, either consecutively or at a certain schedule.

In some embodiments, the vibrational source may be connected to the mouthpiece in such way that the vibration provided is in the sagittal plane of a user's mouth. A motor may be included in the vibrational source to provide such vibration. The motor may be of any suitable type known in the art. The motor, when in use, may be configured to provide vibration at a frequency as disclosed herein. The motor, when in use, may be further configured to provide vibration at an acceleration magnitude. In some embodiments the mouthpiece of a dental vibration device can have an acceleration within a lower bound and an upper bound. The lower bound can be greater than about 0.010 G, 0.015 G, 0.020 G, 0.025 G, 0.030 G, 0.035 G, 0.040 G, 0.045 G, 0.050 G, 0.055 G, 0.060 G, or more; or less than about 0.060 G, 0.055 G, 0.050 G, 0.045 G, 0.040 G, 0.035 G, 0.030 G, 0.025 G, 0.020 G, 0.015 G, 0.010 G, or less. The upper bound can be greater than about 0.07 G, 0.08 G, 0.09 G, 0.10 G, 0.11 G, 0.12 G, 0.13 G, 0.14 G, 0.15 G, or more; or less than about 0.15 G, 0.14 G, 0.13 G, 0.12 G, 0.11 G, 0.10 G, 0.09 G, 0.08 G, 0.07 G, or less.

The motor may be assembled into the vibrational source in an orientation that may provide vibration in such ways.

In some embodiments, sensors may be added to the vibrational dental device, either on the vibrational device, or on the mouthpiece. The sensors may be configured to detect and monitor the parameters of the vibration, for example, frequencies and acceleration magnitudes. The sensors may also be configured to detect if the user has bitten down on the mouthpiece correctly. The sensors may be accelerometers, gyroscopes, proximity sensors, pressure sensors, humidity sensors, temperature sensors, or any combinations of them.

In some embodiments, the mouthpiece could be in contact with at least the teeth, mouth, gums, or implant. The mouthpiece may be configured to be placed in contact with a user's dentition, between and clamped down by both occlusal surfaces of the dentition. The mouthpiece can include ridges or be without ridges. The mouthpiece can cover the entire dentition, or only a part of the dentition. The shape of the mouthpiece can be customized to cover only selected teeth or implants.

### Method For Treating Middle Ear Disorders

According to one aspect of the present disclosure, a method for treating middle ear disorders is described. The method includes providing the mouthpiece of the intraoral vibration device to a user and providing instructions to the user. The instruction may include placement guidelines and dosage information. The dosage information may include duration of each treatment session, number of sessions in a day, number of days, etc. For example, the instruction may instruct a user to use the vibrational dental device for number of times per day. In some embodiments the treatment frequency can be specified to be once per day, twice per day, 3 times per day, 4 times per day, 5 times per day, 6 times per day, 7 times per day, 8 times per day, 9 times per day, or more. In some embodiments the duration of treatment can be specified to be about 1 day, 1 week, 2weeks, 3 weeks, 1 month, 2 months, 3 months, 4 months, 5 months, 6 months, 7 months, 8 months, 9 months, 10 months, 11 months, 1 year, or more.

In some embodiments, the instruction may further include parameters of intraoral vibration. In some embodiments, such parameters may include frequency, acceleration, and dosage. In some embodiments, the frequency may include a frequency to be administered by the intraoral vibration device to the patient. In some embodiments, the frequency may include a frequency that is tuned to maximize or optimize the treatment of one or more middle ear disorders. In some embodiments, the frequency may include a range of frequencies that is tuned to maximize or optimize the treatment of one or more middle ear disorders.

In some embodiments, the instruction may further include additional parameters of intraoral vibration. In some embodiments, such parameters may include frequency, acceleration, and dosage. In some embodiments, the frequency may include a frequency to be administered at various, dynamically changing frequencies according to a type of middle ear disorder. In some embodiments, the frequency may include a frequency to be administered at various, dynamically changing frequencies according to any factor, including but not limited to a characteristic of a patient, a characteristic of an intraoral vibration device, an environmental characteristic, and the like.

In some embodiments, the method may further include configuring the vibrational source providing an axial vibratory force to the mouthpiece. The axial vibratory force may be eventually applied to the dentition through the mouthpiece, which is clamped down by the teeth. The vibratory force (e.g., acceleration magnitudes, frequencies, etc.) can be adjusted by selecting preset values, or fine-tuned by users, technicians, or healthcare professionals.

In some embodiments, the method may further include providing to the patient an intraoral vibration device having a mouthpiece for contacting an oral cavity of the patient, wherein the intraoral vibration device has a frequency tuned to treat a middle ear disorder, and providing instructions for using the intraoral vibration device. In some embodiments, the instructions may include placing the mouthpiece over at least one portion of the oral cavity and applying a vibratory force at the frequency to treat the middle ear disorder.

In some embodiments, the method may further include applying the vibratory force during a predetermined number of sessions. In some embodiments, the method may further include applying the vibratory force throughout a predetermined treatment period. In some embodiments, the frequency for treating the middle ear disorder may include a range of frequencies for treating the middle ear disorder. In some embodiments, the middle ear disorder includes at least one of tinnitus, otitis media (OM), or tensor tympani syndrome (TTS). In some embodiments, the frequency for stimulating production of nasal NO may be variable.

In some embodiments, a session time may be from 30 seconds to 20 minutes. In some embodiments, a session or a plurality of sessions may be repeated daily and/or every other day and/or semi-weekly and/or weekly. In some embodiments, a treatment period is from one day to one year.

In some embodiments, the method may further include determining if the frequency is above or below a set frequency while the mouthpiece is vibrated and adjusting the frequency based upon the determination.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the terms “and/or” and “or” encompass all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A method for treating at least one middle ear disorder in a patient, comprising:
providing to the patient an intraoral vibration device having a mouthpiece for contacting an oral cavity of the patient;
wherein the intraoral vibration device has a frequency tuned to treat the at least one middle ear disorder; and
providing instructions for using the intraoral vibration device, the instructions comprising:
placing the mouthpiece over at least one portion of the oral cavity; and
applying a vibratory force at the frequency to treat the at least one middle ear disorder.

2. The method of claim 1, wherein the vibratory force is applied during a predetermined number of sessions.

3. The method of claim 1, wherein the vibratory force is applied throughout a predetermined treatment period.

4. The method of claim 1, wherein the frequency for treating the at least one middle ear disorder comprises a range of frequencies for treating the at least one middle ear disorder.

5. The method of claim 1, wherein the at least one middle ear disorder comprises at least one of tinnitus, otitis media (OM), or tensor tympani syndrome (TTS).

6. The method of claim 1, wherein the frequency for treating the at least one middle ear disorder is variable.

7. The method of claim 2, wherein a session time is from 30 seconds to 20 minutes.

8. The method of claim 2, where sessions are repeated daily/every other day/semi-weekly/weekly.

9. The method of claim 3, wherein the treatment period is from one day to one year.

10. The method of claim 1, further comprising:
determining if the frequency is above or below a set frequency while the mouthpiece is vibrated; and
adjusting the frequency based upon the determination.
